(19) United States
(12) Patent Application Publication
(10) Pub. No.: US 2015/0372783 A1
(43) Pub. Date: Dec. 24, 2015

(54) METHODS AND APPARATUSES FOR EMPLOYING A SUB-BAND APPROACH TOWARDS DOUBLING TRANSMISSION BANDWIDTH FOR DMT SYSTEMS

(71) Applicant: IKANOS COMMUNICATIONS, INC., Fremont, CA (US)

(72) Inventors: Debajyoti PAL, Saratoga, CA (US); William Edward KEASLER, JR., Tinton Falls, NJ (US)

(21) Appl. No.: 14/746,195

(22) Filed: Jun. 22, 2015

Related U.S. Application Data
(60) Provisional application No. 62/015,179, filed on Jun. 20, 2014.

(51) Int. Cl. H04L 1/00; H04L 5/14; H04B 1/38

(52) U.S. Cl. CPC H04L 1/0002; H04B 1/38; H04L 5/14

(57) ABSTRACT

According to certain aspects, the present invention provides techniques to address G.fast and/or digital subscriber line (DSL) transmission at frequencies below and above 106 MHz in support of aggregate service rates well above 1 Gbps on short loops based on combining two independent first generation G.fast transceivers, each operating up to 106 MHz, into a single transceiver, capable of operating up to 212 MHz and achieving service rates of up to 2 Gbps. In these and other embodiments, a sub-band approach is used in which a total bandwidth is divided into two or more sub-bands, with communications for one or both of the first generation G.fast transceivers using one or both of the sub-bands, respectively.

### CROSS-REFERENCE TO RELATED APPLICATIONS

The present application claims priority to U.S. Prov. Appln. No. 62/015,179, filed Jun. 20, 2014, the contents of which are incorporated by reference herein in their entirety.

### FIELD OF THE INVENTION

The present invention relates generally to data communications, and more particularly to methods and apparatuses for using a sub-band approach for doubling transmission bandwidth for DMT systems.

### BACKGROUND OF THE INVENTION

ITU-T G.9701, commonly referred to as G.fast or the G.fast standard, defines a transceiver specification based on time division duplexing (TDD) for the transmission of the downstream and upstream signals in a bandwidth of approximately 106 MHz. The descriptions herein will refer to a system employing 106 MHz of bandwidth as the “first generation G.fast” system. In G.9701 a second profile for a 212 MHz bandwidth is currently planned for further study, referred to herein as a “second generation G.fast” system. While the 106 MHz profile has been defined and specified (e.g. Profile 106a of the G.fast standard), the 212 MHz profile largely remains undefined (e.g. Profile 212a of the G.fast standard).

Accordingly, there is a need for a method and system for implementing a second generation G.fast system.

### SUMMARY OF THE INVENTION

According to certain aspects, the present invention provides techniques to address G.fast and/or digital subscriber line (DSL) transmission at frequencies below and above 106 MHz in support of aggregate service rates well above 1 Gbps on short loops based on combining two independent first generation G.fast transceivers, each operating up to 106 MHz, into a single transceiver, capable of operating up to 212 MHz and achieving service rates of up to 2 Gbps. In these and other embodiments, a sub-band approach is used in which a total bandwidth is divided into two or more sub-bands, with communications for one or both of the first generation G.fast transceivers using one or both of the sub-bands, respectively.

In accordance with these and other aspects, method for performing discrete multitone (DMT) communications according to embodiments of the invention includes partitioning a wide bandwith into at least first and second non-overlapping sub-bands; performing bonding to allow first and second respective data streams for first and second DMT transceivers to be combined into a single data stream; forming, by the first and second DMT transceivers, first and second digital baseband signals corresponding to the first and second respective data streams; and converting the first and second baseband signals into a single analog signal corresponding to the single data stream, the single analog signal having the wide bandwidth.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram of an example system implementing the sub-band approach of embodiments of the invention;

FIG. 2 is a diagram illustrating an example sub-band plan according to embodiments of the invention; and

FIG. 3 is a block diagram of an example DPU for implementing a sub-band approach toward realizing a second generation G.fast communication services according to embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

According to certain aspects, embodiments of the invention implement a 212 MHz G.fast system, referred to herein as a “second generation G.fast” system. A first generation G.fast transceiver uses 106 MHz of channel bandwidth consisting of 2048 discrete multitone (DMT) tones and a 48 kHz symbol rate. In a second generation system, 212 MHz of channel bandwidth is currently being planned. This system will use 4096 DMT tones operating at a 48 kHz symbol rate.

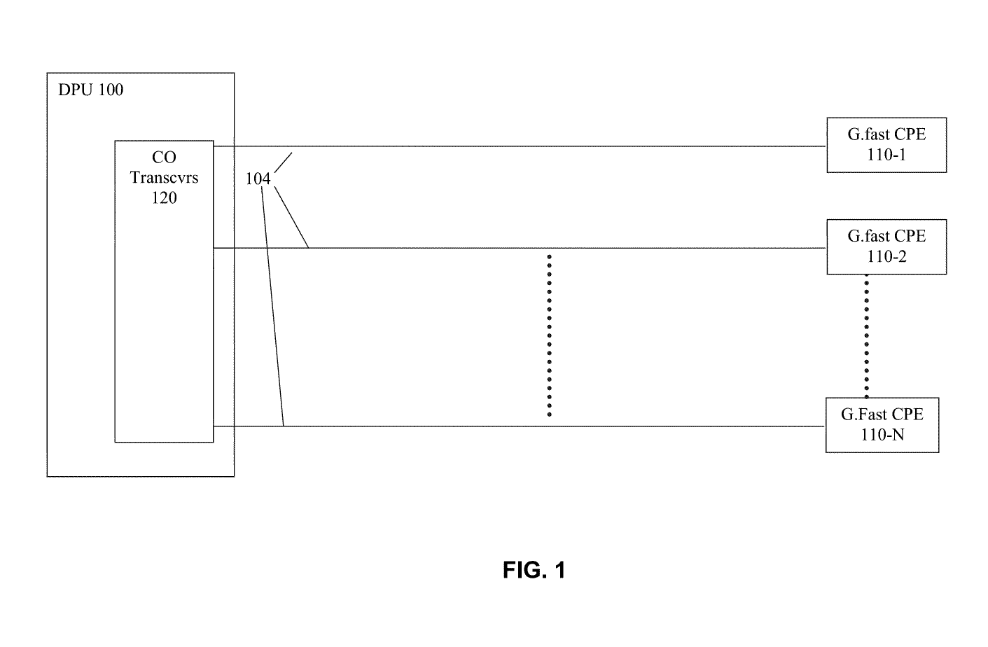

FIG. 1 is a block diagram illustrating an example system for implementing a 212 MHz G.fast system according to embodiments of the invention. As shown, wire pairs 104 are coupled between N G.fast CPE transceivers 110 (e.g. transceivers at customer premises such as homes) and corresponding G.fast CO transceivers 120 in DPU 100. It should be noted that transceivers 110 and 120 can communicate using time domain duplexing (TDD) as defined in the G.fast standard. However, embodiments of the invention can also be implemented in frequency domain duplexing (FDD) schemes such as those described in co-pending U.S. application Ser. No. 14/662,358, the contents of which are incorporated by reference herein in their entirety.

According to one aspect, embodiments of the invention implement a general approach of taking two first generation G.fast transceivers that use up to 2048 tones (i.e. 106 MHz bandwidth) and combining them in a certain way to create a second generation G.fast transceiver that uses up to 4096 tones (i.e. 212 MHz Bandwidth). The G.fast transceivers according to the invention can be included in CO transceivers 120 or both of CO transceivers 120 and CPE transceivers 110.

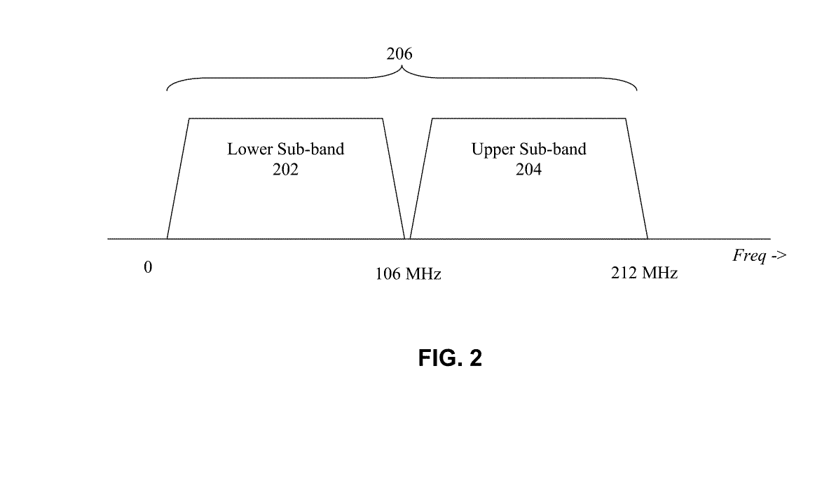

More particularly, the present inventors further recognize that a channel with 212 MHz bandwidth can be broken down into two non-overlapping 106 MHz sub bands. For example, as shown in FIG. 2, a 212 MHz bandwidth channel can be divided into a lower sub band 202 between 0 to 106 MHz and an upper sub band 204 between 106 MHz and 212 MHz, each comprising up to 2048 tones. Each of these sub bands can be mapped to an independent 106 MHz base band channel via appropriate up/down conversion. A first generation G.fast transceiver can send and receive data over either of these single 106 MHz base band channels, with data rates of up to 1 Gbps or more.

According to embodiments of the invention, furthermore, the present inventors recognize that two first generation G.fast transceivers can used in combination to transmit and receive data over a bonded channel 206 using up to the 4096 tones in both of sub-bands 202 and 204, thus providing an aggregate rate well over 1 Gbps. In fact, over very short loops the aggregate data rate could approach 2 Gbps.

It should be noted that the principles of the invention can be extended to future generations of G.fast (e.g. up to 318 MHz) or other high bandwidth systems. In an example G.fast generation operating with bandwidths up to 318 MHz, alternative embodiments of the invention can use three 106 MHz sub-bands and three first generation G.fast transceivers.

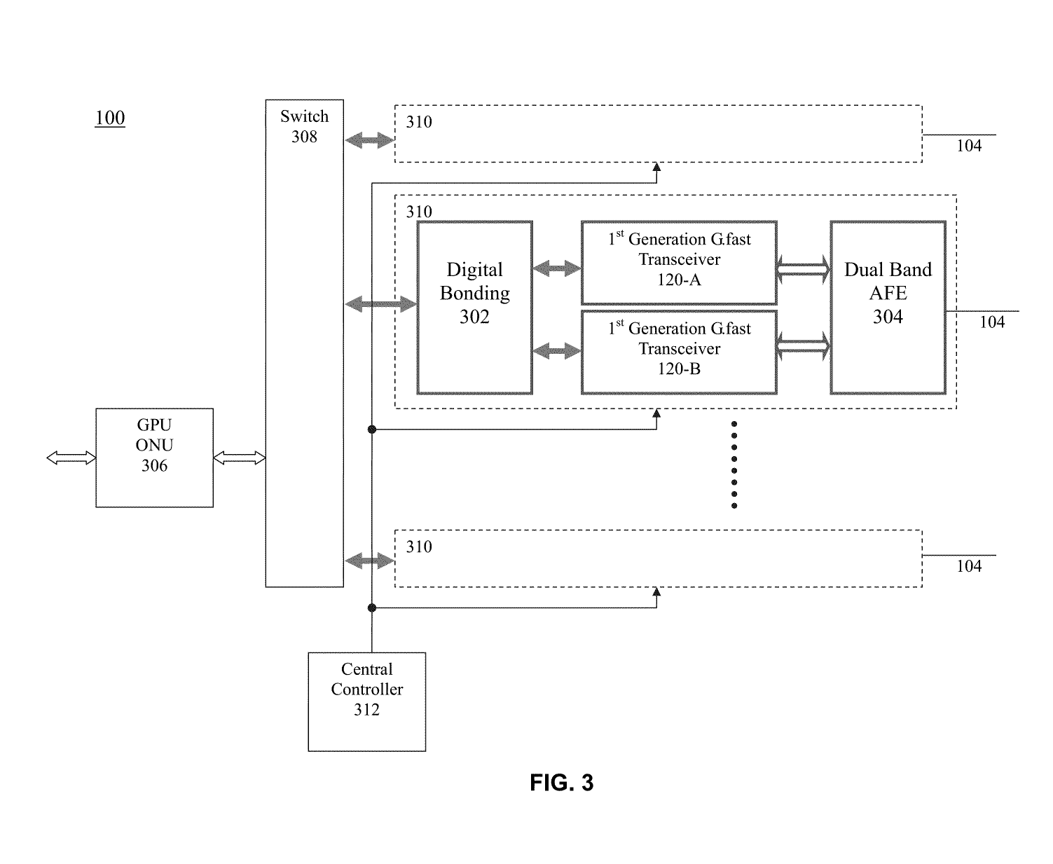

A block diagram illustrating an example DPU 100 for implementing aspects of the present invention is shown in FIG. 3. As shown, DPU 100 includes a fiber optic transceiver (GPON ONU) 306, a switch 308, a central controller 312 and a plurality of configurable channels 310 each coupled to a single line 104. In an alternative example, the GPON ONU 306 can be replaced with an optical, point-to-point Ethernet link. As further shown, each channel 310 includes a digital bonding block 302, a pair of first generation G.fast transceivers 120-A and 120-B, and a dual band analog front end (AFE) 304. It should be noted that DPU 100 may include additional components not shown in FIG. 3, such as components for performing vectoring. However, additional details regarding such additional components will be omitted here for sake of clarity of the invention.

In general operation, during downstream TDD frames, transceivers 120 map user data received from GPON ONU 306 and switch 308 to frequency domain symbols which are converted to time domain digital outputs by transceivers 120 and then to analog signals by AFE 304. As will be described in more detail below, central controller 312 configures channels 310 for operating in one of several different modes to implement either first or second generation G.fast communications on associated line 104. In one possible example, central controller 312 can perform such configuration after or during an initial handshaking session between a transceiver 120 and a corresponding transceiver 110 coupled to line 104, when the capabilities of transceiver 110 are determined. The elements to implement the handshaking session can be located solely within one of transceivers 120A and 120B or duplicated in both 120A and 120B.

Central controller 312 can be implemented by processors, chipsets, firmware, software, etc. such as NodeScale Vectoring products provided by Ikanos Communications, Inc. Those skilled in the art will be able to understand how to adapt these and other similar commercially available products after being taught by the present examples. In a multi-port, single device implementation, controller 312 can be a processor that resides within the device. In a multi-port, multi-device solution, the controller 312 can be located on one multi-port device and communicate to a second multi-port device.

Meanwhile, G.fast transceivers 120 include conventional processors, chipsets, firmware, software, etc. that implement communication services such as those defined by the G.fast standard, as adapted for use in the present invention described in more detail below. Those skilled in the art will be able to understand how to adapt such conventional G.fast products after being taught by the present examples. It should be noted that transceivers 120, bonding module 302 and AFE 304 from several different channels 310 can be incorporated into the same device, for example an 8-port or 4-port, or even 2-port transceiver chip. One fortuitous benefit of having transceivers 120-A and 120-B being contained within a single, multi-port device is the ease of communicating and combining timing recovery primitives between transceivers 120-A and 120-B. An additional benefit is the facilitation of pairing transceivers 120-A and 120-B for the purposes of handshake initialization. It should be further noted that, although shown separately for ease of description, some or all of the components of channels 310 can be incorporated in the same device.

As set forth above, according to embodiments of the invention, central controller 312 can configure the two first generation G.fast transceivers 120-A and 120-B to be bonded using digital bonding module 302 to provide an aggregate rate well over 1 Gbps, and up to 2 Gbps. As configured by central controller 312, digital bonding block 302 can perform any one of several known techniques for performing bonding to combine the bit rates of the two transceivers 120-A and 120-B into one bit stream. For example, module 302 could use Ethernet bonding or a packet transfer mode (PTM) bonding etc.

In an Ethernet bonding example, module 302 can be used to aggregate the traffic to and from transceivers 120-A and 120-B using Link Aggregation Control Protocol (LACP) for Ethernet (see IEEE 802.3ad, or 802.1aq, or 802.1 AX). An additional Ethernet bonding example would be through the use of a bonding subsystem included in 302 that implements ITU-T G.998.2 (derived from the bonding defined in IEEE 802.3ah). Those skilled in the art will be able to implement these and other bonding schemes in channels 310 after being taught by the present examples, and so further details thereof will be omitted here for sake of clarity of the invention.

As shown in FIG. 3, the two first generation G.fast digital transceivers 120-A and 120-B further interface with a dual band AFE 304. An example implementation of AFE 304 is described in co-pending U.S. application Ser. No. ______ (14IK10), which is incorporated by reference herein in its entirety.

In embodiments, central controller 312 configures AFE 304, transceivers 120-A, 120-B and bonding module 302 of each channel 310 to implement one of two modes of operation. As discussed above, such configuration can be performed during or after an initial handshaking session with a corresponding transceiver(s) 110 coupled to the line 104 for each channel 310 to discover its communications capabilities.

In a first mode of operation, a given channel 310 is to be used to interface with a single 106 MHz G.fast CPE transceiver 110. In this case, central controller 312 configures module 302 to disable bonding and to channel data to/from only one of transceivers 120-A and 120-B. Central controller 312 disables the other one of transceivers 120-A and 120-B. Central controller 312 further configures AFE 304 to perform G.fast communications using only lower sub-band 202. The signal on the corresponding line 104 has a maximum bandwidth of 106 MHz using tones in lower sub-band 202.

In a wideband mode of operation, the given channel 310 is to be used to interface with one 212 MHz G.fast CPE transceiver 110. In this case, central controller 312 configures module 302 to perform bonding and to channel data to/from both one of transceivers 120-A and 120-B. Transceivers 120-A and 120-B independently operate to map/demap data using up to 2048 tones in a first generation G.fast scheme. Central controller 312 further configures AFE 304 to cause 106 MHz bandwidth analog signals for transceiver 120-A to use lower sub-band 202 and 106 MHz bandwidth analog signals for transceiver 120-B to use upper sub-band 204. The signal on the corresponding line 104 has a maximum bandwidth of 212 MHz if using all 2 k tones in the lower sub-band 202 and all 2 k tones in the upper sub-band 204.

Certain advantages of the sub band approach of the invention are as follows. First, reuse of first generation (106 MHz profile) transceivers results in lower power consumption and reduced complexity as compared to a single band 212 MHz transceiver. Second, the modular approach allows for either a 106 MHz operation or a 212 MHz operation with half the number of ports using the same digital device. Third, the modular approach also allows for more optimal allocation of digital transceiver resources to mix and match the number 106 MHz channels vs. 212 MHz channels on the same digital device.

Use of the dual band AFE 304 in a mode where it supports two separate 106 MHz channels drastically reduces analog power consumption as compared to a single band 212 MHz analog front end. According to additional aspects, embodiments of the invention achieve efficient utilization of Automatic Gain Control (AGC) on a sub band basis. In particular, the dynamic range of each ADC in AFE 304 is more efficiently utilized by the Automatic Gain Control (AGC) as the ADCs only see “in-band” signals.

It should be noted that many variations of the embodiments of the invention described above can be made to implement additional useful aspects. For example, transceiver 120-B can map tone indices (i.e. frequencies) to achieve frequency inversion with transceiver 120-A (e.g. map data for tone index value k instead into tone 2048-k). The dual band AFE 304 TX path B can then exploit the frequency inversion to grab an image which has the inverse of the inverted tone order.

In another example, when implementing first generation transceiver pair at the CPE, the transceivers can share timing recovery primitives to derive a joint error estimate and to drive a single recovered sampling clock.

In yet another example, a single g.hs session can be used between the CO pair of transceivers 120-A, 120-B and the CPE pair of transceivers 110. At the CO end the single g.hs session is implemented by the 120-A transceiver and at the CPE end the single g.hs. session is implemented by the low frequency transceiver 110.

Alternative implementations according to the invention can also be used for “bonding” two independent first generation G.fast 106 MHz channels (over two different copper lines) to increase data rate. This will require use of two 106 MHz analog front ends (AFEs).

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method for performing discrete multitone (DMT) communications, the method comprising:
partitioning a wide bandwidth into at least first and second non-overlapping sub-bands;
performing bonding to allow first and second respective data streams for first and second DMT transceivers to be combined into a single data stream;
forming, by the first and second DMT transceivers, first and second digital baseband signals corresponding to the first and second respective data streams; and
converting the first and second baseband signals into a single analog signal corresponding to the single data stream, the single analog signal having the wide bandwidth.

2. A method according to claim 1, wherein both the first and second digital baseband signals use tones in one of the first and second non-overlapping sub-bands.

3. A method according to claim 2, wherein a tone index used by the first and second DMT transceivers is the same.

4. A method according to claim 2, wherein a tone index used by the first DMT transceiver is an inverse of a tone index used by the second DMT transceiver.

5. A method according to claim 1, wherein converting includes:
creating a first portion of the analog signal using the first digital baseband signal;
causing the first portion to use the first sub-band;
creating a second portion of the analog signal using the second digital baseband signal; and
causing the second portion to use the second sub-band.

6. A method according to claim 1, further comprising:
receiving an analog signal having the wide bandwidth;
converting the analog signal into third and fourth digital baseband signals;
forming, by the first and second DMT transceivers, third and fourth data streams corresponding to the third and fourth digital baseband signals; and
performing bonding to combine the third and fourth data streams into a single received data stream.

7. A method according to claim 1, further comprising:
disabling bonding for a third data stream;
forming, by only one of the first and second DMT transceivers, a third baseband signal corresponding to the third data stream; and
converting the third baseband signal into another single analog signal corresponding to the third data stream, the another single analog signal having a bandwidth of one of the first and second sub-bands.

8. A method according to claim 7, further comprising:
receiving an analog signal having the bandwidth of one of the first and second sub-bands;
converting the analog signal into a fourth digital baseband signal;
forming, by only one of the first and second DMT transceivers, a fourth data stream corresponding to the fourth digital baseband signal.

9. A method according to claim 1, wherein the first and second DMT transceivers are G.fast transceivers, each operating up to 106 MHz.

10. A method according to claim 7, further comprising:
performing a handshake session with a remote transceiver to determine whether to perform bonding or disable bonding.

11. An apparatus for performing discrete multitone (DMT) communications using a wide bandwidth partitioned into at least first and second non-overlapping sub-bands, the apparatus comprising:
first and second DMT transceivers;
a bonding module that is configured to allow first and second respective data streams for the first and second DMT transceivers to be combined into a single data stream, the first and second DMT transceivers being configured to form first and second digital baseband signals corresponding to the first and second respective data streams; and
an analog front end (AFE) that is configured to convert the first and second baseband signals into a single analog signal corresponding to the single data stream, the single analog signal having the wide bandwidth.

12. An apparatus according to claim 11, wherein both the first and second digital baseband signals use tones in one of the first and second non-overlapping sub-bands.

13. An apparatus according to claim 12, wherein the first and second DMT transceivers use the same tone index.

14. An apparatus according to claim 12, wherein a tone index used by the first DMT transceiver is an inverse of a tone index used by the second DMT transceiver.

15. An apparatus according to claim 11, wherein the AFE includes:
a first digital to analog converter (DAC) that creates a first portion of the analog signal using the first digital baseband signal;
a filter for causing the first portion to use the first sub-band;
a second DAC that creates a second portion of the analog signal using the second digital baseband signal; and
a mixer for causing the second portion to use the second sub-band.

16. An apparatus according to claim 11, wherein:
the AFE is further configured to receive an analog signal having the wide bandwidth and convert the analog signal into third and fourth digital baseband signals;
the first and second DMT transceivers are configured to form third and fourth data streams corresponding to the third and fourth digital baseband signals; and
the bonding module is configured to perform bonding to combine the third and fourth data streams into a single received data stream.

17. An apparatus according to claim 11, further comprising:
a central controller that disables the bonding module from performing bonding for a third data stream, the central controller further causing only one of the first and second DMT transceivers to form a third baseband signal corresponding to the third data stream,
wherein the AFE is further configured to convert the third baseband signal into another single analog signal corresponding to the third data stream, the another single analog signal having a bandwidth of one of the first and second sub-bands.

18. An apparatus according to claim 7, wherein:
the AFE is further configured to receive an analog signal having the bandwidth of one of the first and second sub-bands and to convert the analog signal into a fourth digital baseband signal; and
the central controller causes only one of the first and second DMT transceivers to form a fourth data stream corresponding to the fourth digital baseband signal.

19. An apparatus according to claim 11, wherein the first and second DMT transceivers are G.fast transceivers, each operating up to 106 MHz.

20. An apparatus according to claim 11, wherein one or both of the first and second DMT transceivers are configured to perform a handshake session with a remote transceiver to determine whether to perform bonding or disable bonding.
